(19) United States
(12) Patent Application Publication
(10) Pub. No.: US 2025/0165806 A1
(43) Pub. Date: May 22, 2025

(54) METHOD FOR SUMMARIZING INFRASTRUCTURE ISSUES USING DIRECTED ACYCLIC GRAPHS

(71) Applicant: Hughes Network Systems, LLC, Germantown, MD (US)

(72) Inventor: Aditya Viswanathan KALIAPPAN, Boyds, MD (US)

(21) Appl. No.: 18/510,749

(22) Filed: Nov. 16, 2023

(51) Int. Cl. G06N 5/01

(52) U.S. Cl. CPC G06N 5/01

(57) ABSTRACT

A system and method for summarizing issues of an infrastructure, the method includes: representing possible issues for each of the elements using a Directed Acyclic Graph (DAG) having vertices, where each of the vertices includes a rule, an operation, and a tuple that comprises an issue and a severity; receiving data related to performance of elements within the infrastructure; evaluating, at each of the vertices, the data using the respective rule to identify a respective issue at the respective severity; and summarizing the vertices into core issue vertices for improved human readability and easier diagnosis. Evaluation for an edge vertex is based on the output of the respective rule, while evaluation for a non-edge vertex involves uniting the outputs of direct predecessors with a respective operation. If the union returns True, the evaluation outputs the computation of the rule associated with the vertex; otherwise, it outputs False.

### FIELD

The present teachings relate to the field of infrastructure management, specifically for dynamically summarizing a large set of statistics of an infrastructure including elements, for example, a network infrastructure including network elements. Reasons for underperformance of the elements are represented using a Directed Acyclic Graph (DAG) for a given element and with each vertex of the DAG representing a unique tuple of issue and severity. In some embodiments, the reasons for underperformance may be represented by a union of multiple separate DAGs that form a disjoint set of DAGs. The disjoint set of DAGs are unique over issue and severity across the vertices of the DAGs in the set.

### BACKGROUND

Existing approaches for summarizing issues of an infrastructure have limitations in terms of manual analysis, lack of standardized representation, and limited evaluation capabilities. These approaches can be time-consuming, error-prone, and may not provide a comprehensive overview of the issues present. Additionally, the lack of a standardized framework for representing and evaluating issues can make it difficult to compare and prioritize them based on severity. Furthermore, a lack of a standardized rule-based evaluation system makes it challenging to automate the process and ensure consistent results. The present teachings use of a Directed Acyclic Graph (DAG) or a disjoint set of DAGs to represent possible issues, the evaluation of data using rules and operations, and the summarization of vertices into core issue vertices for improved human readability and easier diagnosis.

An infrastructure may include elements. The infrastructure may collect and compute hundreds of statistics on an element basis, for example, a per-network element basis (e.g., routers, switches). Statistics may identify whether users are enjoying a responsive experience without having to depend on user complaints. A business rule for the element determines whether the statistics indicate a potential issue for the element. As the number of collected statistics and the number of elements in an infrastructure grows, it becomes difficult to diagnose the core set of issues that an element and/or the overall infrastructure is facing.

For example, the infrastructure may be an enterprise network including network elements, such as routers, switches, network transports, LANs, gateways, datacenters, or the like. In a network infrastructure, the statistics may include Key Performance Indicators (KPIs) such as end-user throughput, packet loss, and WAN transport availability/signal quality. The problem of identifying issues/alerts for the network and/or a logical subset of network elements is solved by dynamically summarizing the statistics using a disjoint set of Directed Acyclic Graphs (DAGs) for the network element.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

The present teachings dynamically summarize a large set of active issues/alerts for an infrastructure, a network and/or logical subset of an enterprise network (e.g., gateway, datacenter).

In some aspects, the techniques described herein relate to a computer-implemented method for summarizing issues of an infrastructure, the method including: representing possible issues for each of the elements using a Directed Acyclic Graph (DAG) including vertices, wherein each of the vertices includes a rule, an operation and a tuple that includes an issue and a severity; receiving data related to performance of elements within the infrastructure; evaluating, at each of the vertices, the data using a respective rule to identify a respective issue at a respective severity; and summarizing the vertices into core issue vertices for improved human readability and easier diagnosis. The respective rule evaluates to True when the data indicates the respective issue is raisable at the respective severity due to underperformance or False otherwise. The evaluating, for an edge vertex of the vertices, equals an output of the respective rule, and the evaluating, for a non-edge vertex of the vertices, includes uniting outputs of direct predecessors of the respective vertex with a respective operation, and when the uniting returns True the evaluating outputs a computation of the respective rule associated with the respective vertex otherwise the evaluating outputs False.

In some aspects, the techniques described herein relate to a method, further including adding the direct predecessors of the respective vertex to a suppression list, when the respective rule of the respective vertex evaluates to True.

In some aspects, the techniques described herein relate to a method, wherein the summarizing reports the core issue vertices as the vertices whose respective rule computed to True and are not on the suppression list.

In some aspects, the techniques described herein relate to a method, wherein the summarizing reports the core issue vertices as the vertices that are not on the suppression list.

In some aspects, the techniques described herein relate to a method, wherein the evaluating includes skipping the evaluating of the respective rule of the respective vertex when the respective operation of the respective vertex evaluates to False.

In some aspects, the techniques described herein relate to a method, further including topologically sorting the DAG, in an optimistic or pessimistic mode, to define a traversal for the vertices prior to the evaluating.

In some aspects, the techniques described herein relate to a method, wherein the evaluating unites the respective output of the direct predecessors per the respective operation associated with the respective vertex.

In some aspects, the techniques described herein relate to a method, wherein the rule is based on Boolean operations, relational operations, or a combination thereof.

In some aspects, the techniques described herein relate to a method, wherein one of the elements represents a logical grouping of one or more other elements of the infrastructure, and the evaluating evaluates a respective DAG of each of the one or more other elements prior to evaluating a logical grouping DAG.

In some aspects, the techniques described herein relate to a method, wherein the evaluating of the logical group DAG is based on a latest result from the DAG for each of the one or more other elements.

In some aspects, the techniques described herein relate to a method, wherein the DAG includes one or more disjoint DAGs for one of the elements of the infrastructure.

In some aspects, the techniques described herein relate to a method, wherein the infrastructure includes an enterprise network and the elements include network elements.

In some aspects, the techniques described herein relate to a method, further includes triggering the evaluating and the summarizing for a specific element of the elements.

In some aspects, the techniques described herein relate to a method, wherein the evaluating is performed in a centralized computing paradigm.

In some aspects, the techniques described herein relate to a method, wherein the evaluating is performed in an edge computing paradigm.

In some aspects, the techniques described herein relate to a method, further including storing the respective output from each DAG in a data storage to identify a list of the core issue vertices for a subset of the infrastructure.

In some aspects, the techniques described herein relate to a system for summarizing issues of an infrastructure including: one or more processors configured to: receive data related to performance of elements within the infrastructure; represent each of the elements using a Directed Acyclic Graph (DAG) including vertices, wherein each of the vertices includes a rule, and a tuple that includes an issue and a severity; evaluate, at each of the vertices, the data using the respective rule to identify a respective issue at the respective severity; and summarize the vertices into core issue vertices for improved human readability and easier diagnosis. The respective rule evaluates to True or False depend on whether some of the data indicates the respective issue is raisable at the respective severity due to underperformance. The evaluating, for an edge vertex of the vertices, equals an output of respective rule, and the evaluating, for a non-edge vertex of the vertices, comprises uniting outputs of direct predecessors of the respective vertex with a respective operation, and when the uniting returns True the evaluating outputs a computation of the respective rule associated with the respective vertex otherwise the evaluating outputs False.

In some aspects, the techniques described herein relate to a system, wherein the one or more processors are further configured to add the direct predecessors of the respective vertex to a suppression list, when the respective rule of the respective vertex evaluates to True.

In some aspects, the techniques described herein relate to a system, wherein the one or more processors, when the evaluating, are configured to skip evaluation of the respective rule of the respective vertex when the respective operation of the respective vertex evaluates to False.

In some aspects, the techniques described herein relate to a system, wherein the one or more processors are further configured to topologically sort the DAG, in an optimistic or pessimistic mode, prior to the evaluating.

Implementations of the described techniques may include hardware, a method or process, or a computer tangible medium. Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1A illustrates an optimistic mode DAG, according to various embodiments.

FIG. 1B illustrates a pessimistic mode DAG, according to various embodiments.

FIG. 2. illustrates a network according to various embodiments.

FIG. 3 illustrates a method for summarizing issues of an infrastructure according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The present teachings dynamically summarize a large set of active issues/alerts for an infrastructure, a network and/or logical subset of an enterprise network (e.g., gateway, datacenter). In some embodiments, the present teachings deterministically identify whether an edge element of the infrastructure is underperforming and dynamically summarizes the edge element's set of potential issues into a smaller set of core issues for improved human readability and easier diagnosis. In some embodiments, summarization of issues across higher-level components in the entire enterprise network is provided. Issue summarization processing logic is horizontally scalable as the size of an enterprise network and/or space of potential issues grows.

The teachings support centralized or edge computing paradigms. In centralized computing, an element sends all its raw data to a centralized processing server, which computes all possible issues based on one or more configurable criteria in “batches”. The criteria may be defined based on business rules. In edge computing, an element computes whether it is facing any possible issues based on one or more configurable criteria, and then “streams” these events to a processing server for further analysis.

A Directed Acyclic Graph (DAG) is a type of graph structure where vertices are connected by directed edges in such a way that there are no cycles. DAGs maintain dependencies between vertices, such as in scheduling of dependent tasks or maintenance of version history. In a DAG, data enters a vertex through its incoming edges and leaves the vertex through its outgoing edges. An output of each vertex in the DAG may be based on a rule or operation. Each vertex has one or more input data sets and an output.

Underperformance of an element in the infrastructure may be represented by multiple DAGs, for example, a disjoint set of DAGs. A DAG is a single, acyclic graph; in contrast, a disjoint set of DAGs includes of multiple, disjoint DAGs. In the present teachings, a disjoint set of DAGs represents reasons why an element of an infrastructure may be underperforming using issues and severity. The infrastructure may represent a network, a scheduling of dependent tasks, an order of events, or the like. In some embodiments, each directed edge u→v exists such that either vertices u and v are both for the same issue but for different severities; or vertices u and v are for different issues.

A given DAG may be sorted to define a traversal order for vertices of a DAG. The sort ensures that a vertex is processed only after its dependencies are processed. The sort itself does not determine whether the DAG is optimistic or pessimistic. The arrangement of the vertices (ascending or descending by severity) in the DAG determines whether it is optimistic or pessimistic. The Optimistic mode assumes that a vertex will usually not have any issues. Typically, for an optimistic mode DAG, the direct successors to a given vertex are at a same severity or higher. In contrast, a Pessimistic mode assumes that a site will likely have issues. Typically, the direct successors to a given vertex in a Pessimistic mode DAG are the same severity or lower. When multiple DAGs (for example, a disjoint set of DAGs) is associated with an element, all of the multiple DAGs need not be sorted in a same mode. In other words, some of the multiple DAGs may be sorted in a pessimistic mode while the remainder are sorted in an optimistic mode.

The present teachings use an exemplary network to illustrate the teachings herein. In a network (for example, an enterprise network) hundreds of statistics are computed on a per edge element basis to identify whether customers are enjoying a responsive experience without having to depend on customer complaints. For an element of the network, a DAG may be provided where each vertex of the DAG may be a combination of an issue such as “WAN A packet loss”, “no connectivity”, “degraded beam” or the like. In the vertex, severities may be defined including, for example, “information”, “critical”, “minor”, “major”, or the like.

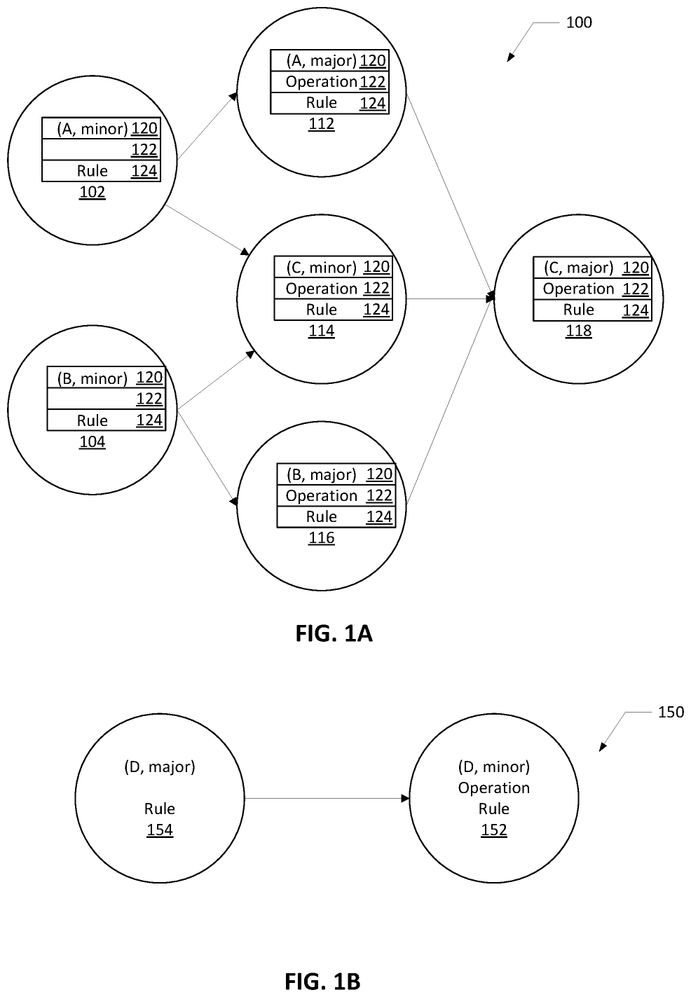

FIG. 1A illustrates an optimistic mode DAG, according to various embodiments.

A DAG 100 may include vertices (vertex 102, vertex 104, vertex 112, vertex 114, vertex 116, vertex 118). The DAG 100 may be termed an optimistic DAG as vertices having the same issue are ordered by severity from minor to major.

Each of the vertices of DAG 100 may include a tuple 120 as a (issue, severity). Each tuple 120 in the vertices of DAG 100 may be a unique tuple of issue and severity.

Each of the vertices of DAG 100 may include an operation 122. Operation 122 may evaluate to True/False. Operation 122 may be a Boolean operation. Each operation 122 of the vertices of DAG 100 may be used to unite outputs of predecessor vertices of a respective vertex. Exemplary operations maintained by the vertex include:
a) AND: all direct predecessors computed a value of True
b) OR: at least one direct predecessor computed a value of True
c) NOR: all direct predecessors computed a value of False
d) NAND: at least one direct predecessor computed a value of False
e) ANY: ignore the computed value of the direct predecessors

Each of the vertices of DAG 100 may include a rule 124. Rule 124 may be a Boolean operation or relational operation on one or more data sets. The relational operation may be a complex string of Boolean/relational operations, depending on the complexity of the rule. Each rule 124 of the vertices of DAG 100 may be used to evaluate an output of a respective vertex. The rule 124 may output True or False depending on whether data for the vertex or predecessors of the vertex indicates that the vertex issue is raisable at the vertex severity.

Predecessors of a vertex are based on a directionality of the DAG. Vertices in a DAG without predecessors are edge vertices. In FIG. 1A for DAG 100, vertex 102 and vertex 104 are edge vertices. Vertices in a DAG that are not edge vertices are also known as non-edge vertices. In FIG. 1A for DAG 100, vertex 112, vertex 114, vertex 116 and vertex 118 are non-edge vertices. Non-edge vertices may have direct and indirect predecessors. In DAG 100, vertex 112, vertex 114 and vertex 116 are direct predecessors of vertex 118; while vertex 102 and vertex 104 are indirect predecessors of vertex 118. Similarly, vertex 102 is direct predecessor of vertex 112 and vertex 114.

In the exemplary DAG of FIG. 1A, the (A, minor) and (B, minor) vertices are direct predecessors of (C, minor), and neither of those vertices have predecessors themselves. Furthermore, (A, minor) has both (A, major) and (C, minor) as direct successors.

FIG. 1B illustrates a pessimistic mode DAG, according to various embodiments.

A DAG 150 may include vertices (vertex 152, vertex 154). The DAG 150 may be termed a pessimistic DAG as vertices having the same issue are ordered by severity from major to minor.

For example, a disjoint set of DAGs includes the optimistic DAG 100 in FIG. 1A and the pessimistic DAG 150 in FIG. 1B. Neither of those DAGs interact with each other but collectively describe issues for the infrastructure element in question. A topological sort of the disjoint set including DAG 100 and DAG 150 may produce the following result: (A, minor)→(B, minor)→(A, major)→(C, minor)→(B, major)→(C, major)→(D, major)→(D, minor). This topological sort may be computed using a breadth-first search through each DAG in the disjoint set. The topological sort ensures a linear ordering of vertices in such a way that all indirect/direct predecessors are processed first. For instance, (A, minor) is processed first because it is not dependent on any other vertices, while (C, major) is processed after all its direct and indirect predecessors. Furthermore, the “D” vertices of FIG. 1B can be processed before any of the other vertices since they are in a separate DAG.

Application of a vertex's operation to direct predecessors evaluates to a True/False value, regardless of the operation applied. For edge vertexes, a vertex's rule may evaluate the vertex's output per a business logic. The business logic is based on statistics of one or more elements of the infrastructure (for example, a network element or logical grouping of network elements). The operation field for edge vertexes is null. For a non-edge vertex, proceeding with the rule computation for that vertex is determined after uniting the outputs of non-edge vertex's direct predecessors. When the uniting evaluates to True, the rule computation is undertaken. When the uniting evaluates to False, the rule computation may be skipped. The uniting may be performed be applying the respective operation (AND, OR, NOR, NAND, ANY) on the outputs of non-edge vertex's direct predecessors.

Outputs of vertices may be True, False. In some embodiments, outputs of one or more vertices may be unavailable. When a direct predecessor's output value is unavailable (for example, because it has not been computed or data to compute it is unavailable, or the like), the output of the direct predecessor may be assigned a dynamic value. In one embodiment, the assigned output value may be set to False when the vertex's operation is AND/OR/ANY, and set to True when the operation is NOR/NAND.

As an example, suppose the following is part of a larger DAG: (E, minor)→(E, major, AND). If (E, minor) is True, the evaluation will compute the rule for (E, major). If (E, minor) is False, the evaluation may skip the rule computation for (E, major). When (E, minor)'s rule is unavailable, (E, minor)'s value will be set to False as (E, major)'s operation is AND; moreover, the rule computation of (E, major) would be skipped, as (E, minor)'s dynamic assignment was set to False.

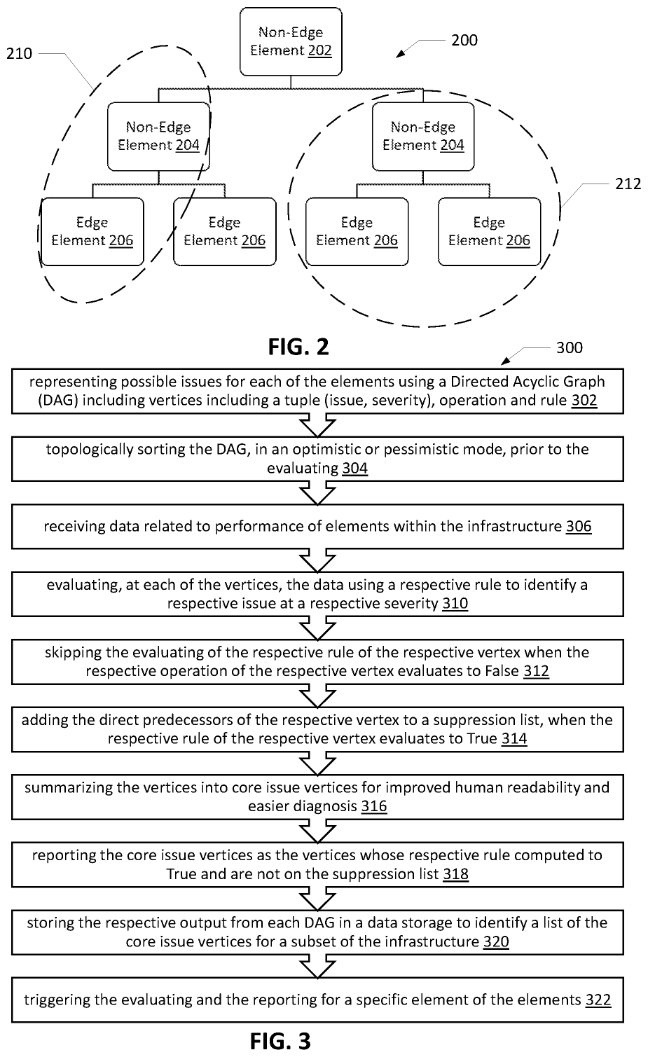

FIG. 2. Illustrates a network according to various embodiments.

A network 200 may include network elements. Some of the network elements are non-edge elements (non-edge element 202, non-edge elements 204) and edge elements 206. A logical grouping of the network 200 may be treated as a network element, for example, logical grouping 210, logical grouping 212. The logical groupings may represent data centers, gateways, local area networks, sub-networks, or the like. A DAG may be associated with each of the network elements, including a logical grouping.

A disjoint set of DAGs evaluated over one element is independent of a disjoint set of DAGs evaluated over a different element or logical grouping (either containing or not containing a respective element). The results generated by a disjoint set of DAGs can be refreshed/reevaluated at any frequency, and any other disjoint set of DAGs may consult with the most recently known results of other DAGs if such data is required as per a business logic of one of the rules associated with vertices of the other DAGs. The potential issues may then be summarized into a smaller set of core issues by suppression of some of the vertices of a DAG for improved human readability and easier diagnosis. One or more DAGs may be associated with an element of the infrastructure.

The evaluation of DAGs can be performed either via a centralized computing paradigm or an edge computing paradigm. In a centralized computing paradigm raw data from a device is processed in “batches”. In an edge computing paradigm raw data is processed/aggregated by edge elements of the infrastructure and sent or streamed to an aggregation server. The aggregation server may receive statistics after processing including issues, severity of the issues, or output of a DAG evaluated at the edge element.

The present teachings may be implemented in a centralized computing paradigm by performing a topological sort on the disjoint set of DAGs. A topological sort of all DAGs for elements of the infrastructure is performed on each DAG individually. The topological sort provides a linear ordering of the vertices in a DAG such that for any given vertex, its direct/indirect predecessors are traversed first.

After sorting, for each vertex in the topological sort, get the results of the direct predecessors of the vertex. When a respective operation on the direct predecessors of the current vertex returns True, evaluate the rule for this vertex. If the respective operation on the direct predecessors of the current vertex returns False, skip the rule evaluation and assume the value of the rule evaluation to be False. If the rule evaluation results in True, add each of the direct predecessors to a suppression list. If the rule evaluation results in False, the current vertex is not a core issue vertex candidate.

After parsing all the vertices, the present teachings report only those vertices that computed a value of True and do not exist in the suppression list. As such, lower or higher (lower for optimistic sort and higher for pessimistic sort) severity vertices of an issue are suppressed to summarize the issues in the infrastructure.

The centralized computing paradigm may be applied to an edge computing paradigm with minor modifications where elements of the infrastructure “stream” issues when these issues are raised and cleared. The edge computing paradigm significantly reduces the computation load when the space of issues can be represented with many small DAGs. In the edge computing paradigm, the topological sort of each DAG is precomputed, and when a new event arrives, only the DAG corresponding to the element associated with the event is traversed and evaluated to identify whether the core set of issues from that DAG have changed. The latest set of core issues to raise is the uniting or union of the issues identified per DAG.

The use of a disjoint set of DAGs can be extended to support consolidation of issues across an enterprise network. The consolidation may keep the existing disjoint set of DAGs used to consolidate issues at the per-element level. The consolidation may construct an additional disjoint set of DAGs to support identifying issues collectively seen by logical groupings of infrastructure elements. This disjoint set identifying issues collectively has mostly the same properties as the per-vertex disjoint set, except for the following minor modifications:
Each vertex maintains a unique (group, issue, severity) tuple where a group is some logical partitioning of devices (e.g., gateway, datacenter).
Each vertex's rule decides whether some number/percent of devices in that group raised an issue for one or more vertices.
Two vertices that are connected by a directed edge are for the same group but a different issue and/or severity; or two vertices that are connected by a directed edge are for different groups, where usually one group is a subset or superset of the other.
Periodically the results are aggregated from the per-element disjoint set of DAGs by evaluating a topological sort of the group disjoint set of DAGs to summarize the core set of issues in an enterprise network.

By virtue of using a disjoint set of DAGs, this issue summarization teachings can be scaled horizontally across a cluster of commodity hardware. More specifically, each server in the cluster can process a subset of DAGs in the disjoint set independently of the other servers. The outputs from each server can be written to a centralized database to identify the full list of summarized issues for a given device and/or the overall enterprise network.

FIG. 3 illustrates a method for summarizing issues of an infrastructure according to various embodiments.

A method for summarizing issues of elements of an infrastructure may include a step 302 for representing possible issues for each of the elements using a Directed Acyclic Graph (DAG) including vertices including a tuple (issue, severity), operation and rule. The method 300 may include operation 304 for topologically sorting the DAG, in an optimistic or pessimistic mode, prior to the evaluating. The method 300 may include operation 306 for receiving data related to performance of elements within the infrastructure. The method 300 may include operation 310 for evaluating, at each of the vertices, the data using a respective rule to identify a respective issue at a respective severity. The method 300 may include operation 312 for skipping the evaluating of the respective rule of the respective vertex when the respective operation of the respective vertex evaluates to False. The method 300 may include operation 314 for adding the direct predecessors of the respective vertex to a suppression list, when the respective rule of the respective vertex evaluates to True. The method 300 may include operation 316 for summarizing the vertices into core issue vertices for improved human readability and easier diagnosis. The method 300 may include operation 318 for reporting the core issue vertices as the vertices whose respective rule computed to True and are not on the suppression list. The method 300 may include operation 320 for storing the respective output from each DAG in a data storage to identify a list of the core issue vertices for a subset of the infrastructure. The method 300 may include operation 322 for triggering the evaluating and the reporting for a specific element of the elements.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A computer-implemented method for summarizing issues of an infrastructure, the method comprising:
representing possible issues for each of the elements using a Directed Acyclic Graph (DAG) comprising vertices, wherein each of the vertices comprises a rule, an operation and a tuple that comprises an issue and a severity;
receiving data related to performance of elements within the infrastructure;
evaluating, at each of the vertices, the data using a respective rule to identify a respective issue at a respective severity; and
summarizing the vertices into core issue vertices for improved human readability and easier diagnosis,
wherein the respective rule evaluates to True when the data indicates the respective issue is raisable at the respective severity due to underperformance or False otherwise,
wherein the evaluating, for an edge vertex of the vertices, equals an output of the respective rule, and
wherein the evaluating, for a non-edge vertex of the vertices, comprises uniting outputs of direct predecessors of the respective vertex with a respective operation, and when the uniting returns True the evaluating outputs a computation of the respective rule associated with the respective vertex otherwise the evaluating outputs False.

2. The method of claim 1, further comprising adding the direct predecessors of the respective vertex to a suppression list, when the respective rule of the respective vertex evaluates to True.

3. The method of claim 2, wherein the summarizing reports the core issue vertices as the vertices whose respective rule computed to True and are not on the suppression list.

4. The method of claim 2, wherein the summarizing reports the core issue vertices as the vertices that are not on the suppression list.

5. The method of claim 1, wherein the evaluating comprises skipping the evaluating of the respective rule of the respective vertex when the respective operation of the respective vertex evaluates to False.

6. The method of claim 1, further comprising topologically sorting the DAG, in an optimistic or pessimistic mode, to define a traversal for the vertices prior to the evaluating.

7. The method of claim 1, wherein the evaluating unites the respective output of the direct predecessors per the respective operation associated with the respective vertex.

8. The method of claim 1, wherein the rule is based on Boolean operations, relational operations, or a combination thereof.

9. The method of claim 1, wherein one of the elements represents a logical grouping of one or more other elements of the infrastructure, and the evaluating evaluates a respective DAG of each of the one or more other elements prior to evaluating a logical grouping DAG.

10. The method of claim 9, wherein the evaluating of the logical group DAG is based on a latest result from the DAG for each of the one or more other elements.

11. The method of claim 1, wherein the DAG comprises one or more disjoint DAGs for one of the elements of the infrastructure.

12. The method of claim 1, wherein the infrastructure comprises an enterprise network and the elements comprise network elements.

13. The method of claim 1, further comprises triggering the evaluating and the summarizing for a specific element of the elements.

14. The method of claim 1, wherein the evaluating is performed in a centralized computing paradigm.

15. The method of claim 1, wherein the evaluating is performed in an edge computing paradigm.

16. The method of claim 1, further comprising storing the respective output from each DAG in a data storage to identify a list of the core issue vertices for a subset of the infrastructure.

17. A system for summarizing issues of an infrastructure comprising:
one or more processors configured to:
receive data related to performance of elements within the infrastructure;
represent each of the elements using a Directed Acyclic Graph (DAG) comprising vertices, wherein each of the vertices comprises a rule, and a tuple that comprises an issue and a severity;
evaluate, at each of the vertices, the data using the respective rule to identify a respective issue at the respective severity; and
summarize the vertices into core issue vertices for improved human readability and easier diagnosis,
wherein the respective rule evaluates to True or False depend on whether some of the data indicates the respective issue is raisable at the respective severity due to underperformance,
wherein the evaluating, for an edge vertex of the vertices, equals an output of respective rule, and
wherein the evaluating, for a non-edge vertex of the vertices, comprises uniting outputs of direct predecessors of the respective vertex with a respective operation, and when the uniting returns True the evaluating outputs a computation of the respective rule associated with the respective vertex otherwise the evaluating outputs False.

18. The system of claim 17, wherein the one or more processors are further configured to add the direct predecessors of the respective vertex to a suppression list, when the respective rule of the respective vertex evaluates to True.

19. The system of claim 17, wherein the one or more processors, when the evaluating, are configured to skip evaluation of the respective rule of the respective vertex when the respective operation of the respective vertex evaluates to False.

20. The system of claim 17, wherein the one or more processors are further configured to topologically sort the DAG, in an optimistic or pessimistic mode, prior to the evaluating.
